(19) United States
(12) Patent Application Publication
(10) Pub. No.: US 2006/0055836 A1
(43) Pub. Date: Mar. 16, 2006

(54) Flat panel display device

(76) Inventors: Jeong-Hwan Lee, Gyeonggi-do (KR); Jong-Dae Park, Seoul (KR); Sung-Yong Kang, Gyeonggi-do (KR)

Correspondence Address: CANTOR COLBURN, LLP, 55 GRIFFIN ROAD SOUTH, BLOOMFIELD, CT, 06002, US

(21) Appl. No.: 10/520,262

(22) PCT Filed: Jul. 9, 2003
(86) PCT No.: PCT/KR03/01359

§ 371 Date: Jan. 5, 2005

(30) Foreign Application Priority Data
Jul. 10, 2002 (KR) 10200240070

(51) Int. Cl. G02F 1/1335

(52) U.S. Cl. 349/14

(57) ABSTRACT

A flat panel display device including a protecting sheet for protecting an upper surface is disclosed. The flat panel display device includes an image display part for displaying an image and a protecting part for protecting an outer surface thereof. The image display part displays the image by varying a voltage applied to electrodes oppositely formed on inner surfaces of a pair of transparent facing substrate respectively to thereby turn on or off each pixel. The protecting part is disposed on an outer surface of the substrate perceived by user's eye from an external shock or foreign mailers. Accordingly, the flat panel display device strongly resist the external shock, and the foreign matters are easily remove from the flat panel display device. The anti-glare treatment is carried out on the protecting sheet to thereby prevent dazzling of users due to the reflection of the light.

### TECHNICAL FIELD

The present invention relates to a flat panel display device, and more particularly, to a flat panel display device including a protecting sheet for protecting an upper surface thereof from an external shock and foreign matters.

### BACKGROUND ART

In general, a flat panel display device has been widely used as the display device for a portable information terminal for the lightness in weight and slimness in volume thereof. In particular, a plasma display panel (PDP) is applied to a most of large-scaled display device because of the characteristics of a high response speed and an excellent viewing angle.

A liquid crystal display (hereinafter, referred to as LCD) device is chiefly used as the display device for a small-scaled display device such as a notebook computer of which size is less than 20 inches or the portable information terminal, for example, a cellular phone, since the response speed of the liquid crystal is relatively low and the LCD device is difficult to be manufactured. However, recent great technical strides on the response speed and viewing angle make it possible for the LCD device to have a display panel of which size is 20 inches or more. Accordingly, the LCD device can be installed to the large-scaled display device having a screen more than 20 inches such as a television set.

In general, the LCD device requires that the incident light on a liquid crystal display panel on which an image is displayed vibrate in just one direction rather than in all directions regardless of a kind of the light, a natural light or an artificial light, so that polarizing plates are installed to the liquid crystal display panel.

In more detail, light is a kind of electromagnetic wave, which is a transverse wave and sinusoidally vibrates perpendicularly to the direction of the propagation thereof. At that time, the light vibrates in all directions in a normal plane perpendicular to the direction of the propagation thereof to thereby have no directivity. However, when the light is incident on the polarizing plate, some of the light vibrating parallel with the axis of a crystal of the polarizing plate passes through, and the other light vibrating non-parallel with the axis of a crystal of the polarizing plate cannot pass through the polarizing plate. Therefore, the light passing through the polarizing plate can vibrate just in one particular direction to thereby have directivity. The polarizing plate can be installed to both outer surface of the liquid crystal display panel for enhancing light efficiency.

The conventional LCD device having the polarizing plate includes a liquid crystal display panel for displaying an image including upper and lower glasses and liquid crystal interposed between the upper and lower glasses, a backlight for providing light to the liquid crystal display panel, and polarizing plates installed on outer surfaces of the upper and lower glasses. In general, the polarizing plate includes a base layer, support layers formed on both upper surface and lower surface of the base layer, and protecting layers. The base layer is formed into a polyvinyl alcohol layer, a kind of a high molecular polarizing substance. In addition, the support layer is formed into a triacetyl cellulous (TAC) layer. An upper protecting layer is installed on the upper support layer, and an adhering layer and a lower protecting layer is sequentially installed on the lower support layer. The support layer is used for improving endurance, mechanical strength, thermal resistance, and wet resistance of the polarizing plate, and the adhering layer is used for adhering the polarizing plate to the glass.

In the mean time, in order to be installed to the large-scaled display device having a large screen such as a television set, the LCD device is also required to improve outward appearances as well as the physical and electrical characteristics such as the above-described response speed or viewing angle.

The surface of the television set comes most frequently into contact with users inevitably, so that the liquid crystal display panel of the television set is easily damaged by an external shock and foreign matters are easily adhered to the surface of the liquid crystal display panel. A frequently repeated external shock damages the upper polarizing plate of the liquid crystal display panel, so that the image is distorted. In addition, the foreign matters adhered to the surface of the liquid crystal display panel also make the image distorted. Furthermore, when users familiar with a cathode-ray tube (CRT) of the television set clean the surface of the liquid crystal display panel up, the upper polarizing plate can also be damaged by cleansers, so that the image can be distorted.

### DISCLOSURE OF THE INVENTION

Accordingly, the present invention is directed to a flat panel display device that substantially obviates one or more problems due to limitations and disadvantages of the related art.

The present invention provides a flat panel display device having a shock-resistance against an external shock.

The present invention also provides a flat panel display device for preventing surface defects due to frequent touches on a surface thereof by users, especially when the flat panel display device has a large-scaled screen.

In one aspect of the invention, a flat panel display device is provided which comprises an image display part for displaying an image by varying a voltage applied to electrodes oppositely formed on inner surfaces of a pair of transparent facing substrate respectively to thereby turn on or off each pixel, and a protecting part disposed on an outer surface of the substrate perceived by user's eye for protecting a surface of the image display part from an external shock or foreign matters.

As an exemplary embodiment, the image display part includes a liquid crystal display (hereinafter, referred to as LCD) device having liquid crystal interposed between the pair of transparent facing substrate, and a diffusing process is performed on the protecting part for enhancing an anti-glare characteristic of the protecting part. In addition, the protecting part includes a protecting sheet formed of non-polarized polycarbonate or polyethylene terephthalen (PET) and having a hardness of about 2H or more.

As an exemplary embodiment, the LCD device includes a) a lower polarizing plate for polarizing light, b) a liquid crystal display panel for displaying an image by using a polarized light emitted from the lower polarizing plate and the liquid crystal, and c) an upper polarizing plate disposed on an upper surface of the liquid crystal display panel for polarizing light emitted from the liquid crystal display panel. Preferably, the protecting sheet is laminated on or adhered to the upper polarizing plate.

According to the present invention, the protecting sheet is installed on a surface of the flat panel display device, so that the flat panel display device can resist the external shock and the foreign matters are easily removed. In addition, the anti-glare characteristic of the protecting sheet is improved to thereby prevent dazzling of the users due to a reflection of the light.

### BRIEF DESCRIPTION OF THE DRAWINGS

The above and other features, aspects and advantages of the present invention will become readily apparent with regarding to the following detailed description on best mode for carrying out the invention and appended claims when considered in conjunction with the accompanying drawings wherein:

FIG. 1 is a block diagram illustrating a process for displaying an image using a flat panel display device according to the present invention;

FIG. 2 is a cross sectional view showing a liquid crystal display device installed to the flat panel display device as shown in FIG. 1; and

FIG. 3 is a cross sectional view showing an upper polarizing plate installed to the liquid crystal display device as shown in FIG. 2.

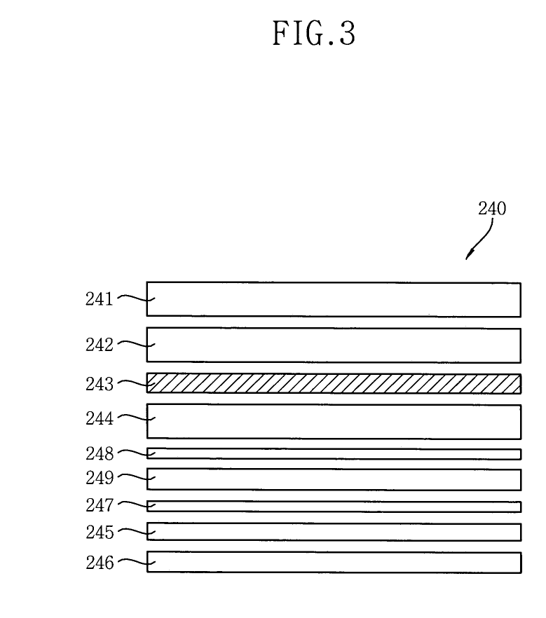

### BEST MODE FOR CARRYING OUT THE INVENTION

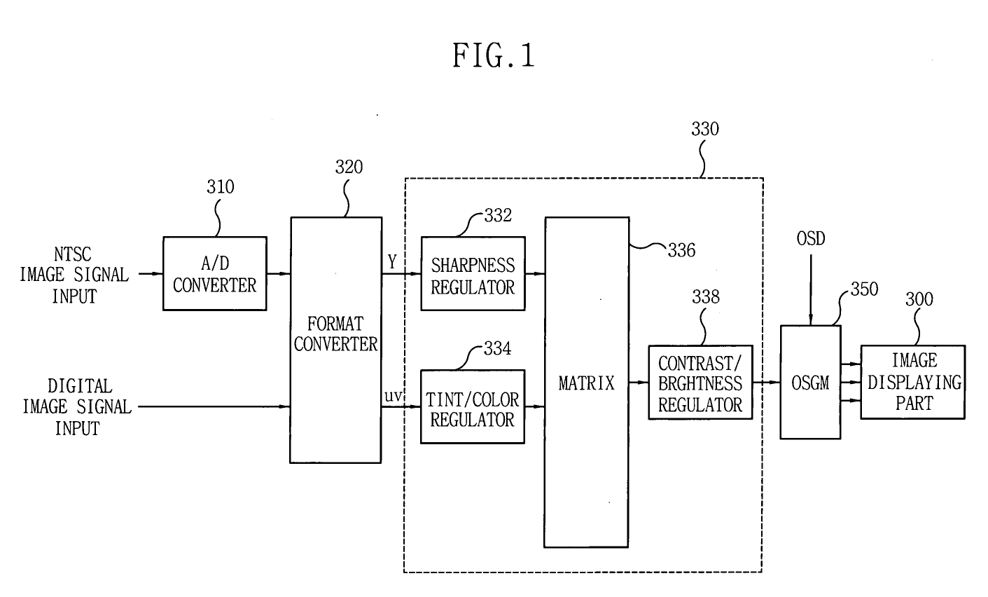

FIG. 1 is a block diagram illustrating a process for displaying an image using a flat panel display device according to the present invention. As one exemplary embodiment, FIG. 1 shows a process for displaying an image using an LCD device in a television set which can use both digital signal and analogue signal. The process for displaying an image in a television set is exemplary selected for describing the best mode for carrying out the present invention, since the function of the protecting sheet is most apparent in the television set. Accordingly, it is obvious that the scope of the present invention is not limited to the television set.

Referring to FIG. 1, a flat panel display device according to an exemplary embodiment of the present invention includes an A/D converter 310, a format converter 320, a data characteristic regulator 330, and an image displaying part 300.

The A/D converter 310 converts analogue image signals received from a broadcasting station such as a national television system committee (hereinafter, referred to as NTSC) image signals into digital image data. The format converter 320 changes the format type of the digital NTSC image data and an image data extracted from the digital image signals received from the broadcasting station according to the display standard. The data characteristic regulator 330 regulates the characteristics of the format-changed image data according to a use's control. The image displaying part 300 displays an image corresponding to the image data of which characteristics are regulated by the data characteristic regulator 330. As one exemplary embodiment, an LCD device is used as the image displaying part 300. The flat panel display device can further include an on-screen-graphic-mixer (OSGM) 350. The OSGM inserts on-screen-display (OSD) characters, which is simultaneously displayed with an image, to the image data of which characteristics are regulated, so that the image corresponding to the image data and the characters inserted to the image data are simultaneously displayed on the image displaying part 300 of the television set.

The data characteristic regulator 330 includes a sharpness regulator 332, a tint/color regulator 334, and a matrix 336, and a contrast/brightness regulator 338. The sharpness regulator 332 regulates the sharpness of an image by using a luminance data Y of the format-changed image data, and the tint/color regulator 334 regulates the tint and color of an image by using two color-difference data U and V of the format-changed image data. The matrix converts the regulated luminance data Y and two color-difference data U and V into a color data of red, green and blue. The contrast/brightness regulator 338 regulates the contrast and brightness of the color data of red, green and blue.

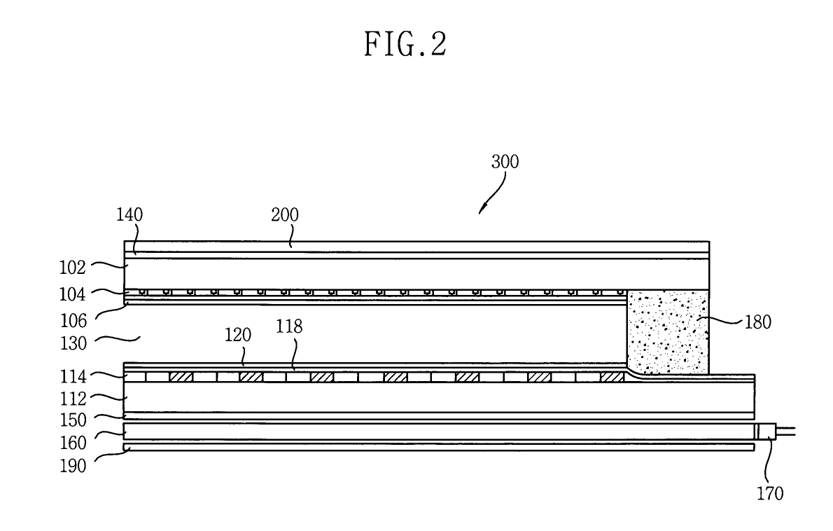

FIG. 2 is a cross sectional view showing a liquid crystal display device installed to the flat panel display device as shown in FIG. 1.

Referring to FIG. 2, a first polarizing plate 140 is disposed on an outer surface of a first substrate 102. An image is displayed op the outer surface of the first substrate and perceived by user's eye. A protecting sheet 200 is disposed on the first polarizing sheet.

A diffusing process is carried out to the protecting sheet 200, so that the protecting sheet 200 has anti-glare characteristic. Furthermore, the protecting sheet 200 is formed of non-polarized polycarbonate or polyethylene terephthalen (PET) and has a hardness of about 2H or more so as to resist the external shock. As an exemplary embodiment, the protecting sheet 200 is laminated on or adhered to the first polarizing plate 140.

As one exemplary embodiment, the first substrate 102 is formed into a transparent substrate, and a plurality of pixel electrodes and a plurality of switching devices 104 are formed on an inner surface thereof. A first alignment layer 106 is formed below the plurality of pixel electrodes and switching devices 104.

A second substrate 112 is disposed facing the first substrate 102, and also formed into a transparent substrate. A color filter layer 114 for generating a color image, a common electrode 118 and a second alignment layer 120 are sequentially formed on an inner surface of the second substrate 112. The common electrode 118 generates an electrical field together with the pixel electrodes 104, and the second alignment layer 120 determines a pre-tilt angle of liquid crystal molecules in the liquid crystal layer 130 together with the first alignment layer 106.

A second polarizing plate 150 is disposed below the second substrate 112. Accordingly, the light vibrating just in one direction can pass into the second substrate 112.

As an exemplary embodiment, a light guiding plate 160 is disposed under the second polarizing plate 150 so as to guide the light provided from a side portion thereof to the second substrate 112. A light source 170 for generating light is disposed at the side portion of the light guiding plate 160. Anything radiating light is sufficient for the light source 170 such as a fluorescent lamp, a light emitting diode (hereinafter, referred to as LED), an electro luminescent (hereinafter, referred to as EL) device, and a small incandescent electric lamp. However, the LED, an organic EL device, or the small incandescent electric lamp is most preferable for low power consumption since additional appliances such as an inverter is not required and a relative low voltage is needed. Most preferably, the LED is used for reducing the size of the LCD device.

The light guiding plate 160 changes a line light source such as a lamp into a surface light source. A reflecting plate 190 is disposed under the light guiding plate 160 for reflecting the light leaked from the light guiding plate 160 toward the first substrate 102. As an exemplary embodiment, optical sheets such as a diffusing sheet and a prism sheet can be additionally installed between the light guiding plate 160 and the second substrate 112. The diffusing sheet can diffuse the light emitted from the light guiding plate 160, and the prism sheet can make the viewing angle of the light emitted from the diffusing sheet narrow. As an exemplary embodiment, the first and second substrate includes an inorganic transparent substance such as a glass, high polymers in a shape of sheet or film, or a complex thereof.

While the present invention has been described in connection with an edge type backlight assembly in which the light guiding plate, the diffusing sheet and the prism sheet are disposed under the liquid crystal display panel for providing light thereto, it will be obvious to those having skill in the art that the present invention is also useful for a direct type backlight assembly in which a series of lamp is disposed under the liquid crystal display panel without the light guiding plate.

Described below is an operation of the television set including the liquid crystal display device constructed as the above description.

Firstly, the NTSC image signal received from the broadcasting station is inputted to a microprocessor, and then is converted into two different signals, luminance signal and two color-difference signals. Subsequently, the converted signals are transferred to the matrix. The matrix converts the luminance signal and two color-difference signals into color signal of red, green and blue according to a predetermined matrix equation, and transfers the color signal into the data characteristic regulator. The data characteristic regulator regulates the contrast, the tint, the color and the brightness of the color signal of red, green and blue according to user control. Then, the regulated color signal of red, green and blue is converted into digital signal by the A/D converter, and is inputted into a video controller of the LCD device. The video controller separates the digital color signal into data signals and gate signals. The pixel electrodes of the LCD device are selectively turned on or off by the data signals and gate signals to thereby display an image on the screen of the television set.

While a personal computer or a portable telephone is used by only one user, the television set is used by various users in common. As a result, the external shock is often applied on the screen of the television set, and the screen is usually stained with foreign matters. According to the present invention, a protecting sheet is installed to the LCD device of the television set to thereby absorb the exterior shock. Furthermore, the foreign matters stained on the screen can be easily removed by using warm water or a detergent. Cleaning the screen of the television set without the protecting sheet by using the warm water or the detergent causes damage to the first polarizing plate 140, which results in image distortion. The protecting sheet according to an exemplary embodiment of the present invention includes the polycarbonate or the PET that strongly resist the external shock to thereby be able to protect the polarizing plate without damage.

The protecting sheet 200 is formed to be transparent without polarizing characteristic, so that the light passing through the first polarizing plate 140 can transmit thereto without distortion.

Furthermore, the diffusion treatment, which means an anti-glare treatment, is carried out on the protecting sheet 200, so that dazzling of the users caused by the reflection of the incident light can be prevented. While the anti-glare treatment is carried out on the protecting sheet, a glare treatment is carried out on the first polarizing plate 140. The second polarizing plate 150 disposed under the second substrate 112 undergoes any one treatment selected the anti-glare treatment and the glare treatment.

In the mean time, the LCD device applied to the flat panel television set can be modified and changed as follows.

Dependency on the viewing angle in the liquid crystal display panel is caused by the difference of double refraction effect. The double refraction of the light slantingly incident on the liquid crystal display panel is different from that of the light vertically incident thereon in effect, which leads to the dependency on the viewing angle. Therefore, optical device for changing a magnitude of the double refraction at an incidence stage is interposed to the liquid crystal display panel to thereby compensate for the difference of the double refraction effect. As one exemplary embodiment, a phase difference compensation film is used as the optical device.

The phase difference compensation film is coupled to the first polarizing plate. In more detail with reference to FIG. 5, a polyvinyl alcohol layer of high polymer polarizing material is formed as a base layer 243, and then a upper support layer 242 and a lower support layer 244 including triacetyl cellulose (TAC) are respectively adhered to an upper surface and lower surface of the polyvinyl alcohol layer 243. An upper protecting layer 241 is formed on the upper support layer 242, and a phase difference compensation film 247 including discotic liquid crystal disposed below the lower support layer 244 with a thickness of about 2 μm. A first adhering layer 248 and a supplementary support layer 249 are sequentially interposed between the lower support layer 244 and the phase compensating layer 247 with a thickness of about 25±5.0 μm and 100±10.0 μm, respectively. Then, a second adhering layer 245 and a lower protecting layer 246 are sequentially disposed below the phase compensating layer 247. At that time, the upper and lower support layer 242 and 244 are used for improving endurance, mechanical strength, thermal resistance and wet resistance of the polarizing plate, and the second adhering layer 245 is used for adhering the polarizing plate 240 to the first and second substrate 102 and 112.

However, a reliability test on the LCD device including the above-described polarizing plate may show that light is severely leaked from an edge portion of the polarizing plate, which is not observed in the conventional polarizing plate. The first adhering layer 248 added in forming the phase difference compensation film deforms by the heat concentrated on an edge portion of the liquid crystal display panel at high temperature. The deformation of the first adhering layer 248 leads to entanglement between the lower support layer 244 and the phase difference compensation film 247 and shrinkage thereof, which give rises to the light leakage.

Accordingly, another exemplary embodiment of the resent invention provides a light compensation polarizing plate in which the lower polarizing plate is formed into non-coupling type, and the phase difference compensation film is installed for preventing the light leakage. Therefore, the light compensation polarizing plate is used as the upper polarizing plate to thereby prevent the light leakage at the edge portion of the liquid crystal display panel.

While the protecting sheet according to an exemplary embodiment is described to protect the screen of the flat panel display device including the liquid crystal display panel, it is obvious to those having skill in the art that the screen of the flat panel display device including a plasma display panel or an electro luminescent display panel can also be protected by the protecting sheet.

### INDUSTRIAL APPLICABILITY

According to the present invention, the flat panel display device can strongly resist the exterior shock, and foreign matters are easily removed from the flat panel display device by using the protecting sheet. In addition, the anti-glare treatment is carried out on a surface of the protecting sheet to thereby prevent dazzling of users due to the reflection of the light. Furthermore, the phase compensating plate is installed to the upper polarizing plate to thereby improve the viewing angle of the LCD device. The light compensation polarizing plate is used as the upper polarizing plate to thereby prevent the light leakage at the edge portion of the liquid crystal display panel.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

1. A flat panel display device, comprising:
an image display part for displaying an image by varying a voltage applied to electrodes oppositely formed on inner surfaces of a pair of transparent facing substrate respectively to thereby turn on or off each pixel; and
a protecting part disposed on an outer surface of the substrate perceived by user's eye for protecting a surface of the image display part from an external shock or foreign matters.

2. The flat panel display device of claim 1, wherein the image display part includes a liquid crystal display device including liquid crystal interposed between the pair of transparent facing substrate.

3. The flat panel display device of claim 2, wherein the liquid crystal display device includes a) a lower polarizing plate for polarizing light, b) a liquid crystal display panel for displaying an image by using a polarized light emitted from the lower polarizing plate and the liquid crystal, and c) an upper polarizing plate disposed on an upper surface of the liquid crystal display panel for polarizing light emitted from the liquid crystal display panel.

4. The flat panel display device of claim 3, wherein a glare treatment is carried out on the upper polarizing plate, and an anti-glare treatment is carried out on the protecting sheet.

5. The flat panel display device of claim 3, wherein the protecting part includes a protecting sheet adhered to the upper polarizing plate.

6. The flat panel display device of claim 3, wherein the protecting part includes a protecting sheet laminated on the upper polarizing plate.

7. The flat panel display device of claim 3, wherein the upper polarizing plate and the lower polarizing plate include a phase compensating member for enhancing viewing angle.

8. The flat panel display device of claim 7, wherein the upper polarizing plate and the lower polarizing plate include a light compensation polarizing member for preventing light leakage at an edge portion of the liquid crystal display panel.
